(19) United States
(12) Patent Application Publication
(10) Pub. No.: US 2016/0277377 A1
(43) Pub. Date: Sep. 22, 2016

(54) Privacy and Performance Tuning Apparatus for a Versioned File Block Access Method

(71) Applicant: Roger March, Santa Clara, CA (US)

(72) Inventor: Roger March, Santa Clara, CA (US)

(21) Appl. No.: 14/664,857

(22) Filed: Mar. 21, 2015

(51) Int. Cl. H04L 29/06; G06F 11/14; H04L 29/08

(52) U.S. Cl. CPC H04L 63/08; H04L 63/12; H04L 67/1004; G06F 11/1402

(57) ABSTRACT

File blocks of version-controlled files are individually provisioned, tracked, load-balanced, and secured by an interposer apparatus. A combination of application, resource location, schedule and user authentication is verified by the apparatus prior to reading, writing, or operating on each file block. Recording past traffic patterns in the network enables the apparatus to tune performance by staging file blocks in the vicinity of most commonly utilized storage or processor resources as well as to alert on or suspend atypical data flows. Analyzing traffic records enable optimization of storage performance by tracking patterns of congestion. Authenticating each application prevents corruption or data breaches. A file system viewport interposed between an application server and a distributed file system records block traffic and consults a rules database to provide security and privacy beyond conventional access control lists.

### BACKGROUND OF THE INVENTION

1. Technical Field

File system optimization and data security.

2. Description of the Related Art

As is known by U.S. Pat. No. 8,874,534 issued October 2014, a block-based version control system can be provided by a system of file state subset satellite apparatuses. A coherent file system and method of operation for a file state authority is coupled to file state sub-set satellites to address congestion and latency effects on a plurality of peer workstation clients organized in neighborhoods. Very large files are versioned and metadata recorded in a file state view determines which file blocks make up each version of a committed file. Metadata may be requested from neighboring workstations to locate desired file blocks. File block transmission is minimized to fulfill read requests only when not accessible at a workstation's local file block store.

As is known, conventional post hoc intrusion detection depends on analysis of file system logs but cannot preemptively deny a particular application from specific access to a specific file.

As is known, conventional file system security depends on permissions and user identification. Once authenticated, the user has free rein to operate on a file with any command at his disposal and permissions.

As is known, a plurality of peer workstation clients first transmit only metadata about versions of files upon request and, subsequently, file blocks only when needed to fulfill a file block read of a particular version. A file state view at each workstation client enables access to file blocks of every version of each file that the user currently has in local store. A peer file system view at each workstation client enables access to file blocks of versions previously stored by other users and may be more or less out of date. A file state sub-set satellite collects metadata from a group of neighboring workstation clients. A plurality of file state sub-set satellites may exchange metadata among one another and answer a request from a workstation client who has gotten no response from its neighbors. A coherent file state authority receives via the sub-set satellites, all the metadata from all the workstation clients in the coherent file system but only transmits on exceptional circumstances e.g. disaster recovery, restoration, or initializing new satellites. Generally files are not distributed at all and only file blocks are transmitted upon request. Metadata about file states are optimized among peers and minimized up to or down from the coherent file state authority to reduce latency due to congestion.

One example of a conventional system previously disclosed by the applicants is a system comprising a first peer workstation client apparatus communicatively coupled to at least one other peer workstation client apparatus, each workstation client apparatus comprising: a processor configured by computer executable instructions to store, retrieve, and transform data and to track versions of files which are made up of file blocks and to intercept file block read and file block write commands issued by a program product; a file state view circuit configured to create, store, and retrieve metadata about file blocks, the versions of files that each block is a component of, and the location of each block in a local file block store whereby file blocks that are identical in multiple versions of a file are not redundantly stored; the local file block store for all file blocks that comprise versions of files whose metadata is stored in the file state view circuit, coupled to both the processor and to the file state view circuit; and at least one peer file system view circuit, whereby each peer file system view circuit stores and provides metadata previously received from other peer workstation client apparatuses about each file block previously stored in the file block store of each other peer, the version of the files each file block was previously a component of, and all the versions of all the files which were previously accessible to the other peer workstation client apparatus, and the location of each file block in the local file block store of the peer workstation client apparatus.

As is known, humans are often the weakest link in a privacy/data security system. LDAP directory servers amplify the problem by enabling single sign-on access when any malicious software is succeeds at user identity theft.

It is known that version control systems manage each file block of a file version in a distributed access method to avoid congestion and single point of failure. A problem of risk exists when low level contract employees (system administrators) have powerful privileges (superuser, root) across an information technology infrastructure.

Thus, what is needed is higher granularity both for privacy and for tuning the performance of a block based distributed file version provisioning system.

### BRIEF SUMMARY OF THE INVENTION

The present invention is a gateway system interposed between one or more application servers and a distributed file block system. Because the applications are cabined away from the actual file system, file blocks, each appropriate to a version of a file selected by a user, are provisioned on demand to each application.

The distributed location of every file block of every version of a file avoids congestion and a single point of failure.

An interposer apparatus isolates every user from the actual file system. Each file block of a version-controlled file is individually provisioned, tracked, load-balanced, and secured.

When a user desires to read, write, or operate on a file block of a versioned file, the apparatus verifies a combination of application, resource location, schedule, and user authentication either before performing the request or before completing the request.

The apparatus records past traffic patterns in the network. From a privacy point of view, the apparatus can then recognize an atypical data flow and raise an alarm or record the details of the incident for review or remediation. Termination or escalation of an incident may at least limit data loss.

From a performance perspective, the apparatus stages file blocks in the vicinity of most commonly utilized storage or processor resources to lower latency for an anticipated file block traffic pattern.

The apparatus measures desuetude of file blocks in one vicinity. While anticipating future traffic patterns may be done by replicating the recent past, a more sophisticated method will consider time of day, calendar, and a financial or engineering workflow (e.g. release day, fiscal year closing, 3 day holiday sale weekend).

Each file block may be stored in plaintext or in encrypted form. Decryption may occur in the application or performed on the fly by the apparatus after authenticating the application, the user, the resource location, or two or three of the preceding. Some file versions may consist of all encrypted blocks, all plaintext blocks, or some mixture of encrypted and plaintext blocks. In almost all cases this provides higher performance compared with file level encryption/decryption.

The configuration of the file block system may be tuned to optimize performance. The gateway system records and reports on which file blocks are required for what application server and thereby supports an effort to remediate congestion. The present invention includes pattern recognition circuits and methods to match file block traffic with application usage. When a pattern of file block traffic is uncharacteristic for its intended use, it may be first noted and possibly interrupted. The present invention may also authenticate applications to determine if they are unchanged from their released version or have been tampered with or are not what they seem. File blocks may be associated with certain signed applications and be unavailable to applications which fail signature verification. One way to enforce privacy and security concerns is to encrypt files blocks at rest and only decrypt them when provisioning to their proper applications.

One aspect of the present invention is an apparatus that presents to an application, a viewport into a distributed file block system. In the context of a selected version of a file, file blocks are accessed by transformation by the viewport of a file block request. Each of these access requests is stored into a transaction activity store coupled to the viewport. Also attached to the transaction activity store is a pattern agent, a circuit that determines and recognizes patterns in file block accesses. Coupled to the pattern agent is a rules engine that is coupled to a rules base store. The rules base enables or disables certain applications from certain file blocks as well as managing time of day and other patterns of file block access. The rules engine applies these rules to the patterns observed by the pattern agent. The rules engine is coupled to the viewport in such a way as to interrupt further file block access when a violation of a rule occurs. In an embodiment, the apparatus also includes a decryption/encryption engine coupled to the viewport that is enabled by the rules engine.

Another aspect of the file block gateway is a method of operating a processor to perform steps related to provisioning an application server with file blocks stored in the non-transitory media of a distributed file block system. The processor that is between the application server and the file system receives and stores all file block requests. By analyzing patterns in the file block requests, the method can identify congestion as well as uncharacteristic patterns. Reading a rules base for each application identifies patterns. The method blocks out of norm file block operations before they are consummated. The file block gateway also is enabled to authenticate applications to ensure they are trusted. Each trusted application is enabled to access certain file blocks and not others. When file blocks are stored in encrypted form, the method includes decrypting the blocks for authenticated applications.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of a processor which provides means to execute instruction steps of a method for transforming, fulfilling, or denying file block access requests;

FIG. 2 is a system block diagram of a file block gateway which connects a user to a distributed file system;

FIG. 3-7 are schematics of components of an apparatus; and

FIG. 8-11 are flowcharts of method steps to control a processor coupled to a non-transitory instruction store.

### DETAILED DISCLOSURE OF EMBODIMENTS OF THE INVENTION

The present invention provides isolation to one or more application servers from the details of a distributed file block storage center. In doing so, the distribution of file blocks can be automatically adjusted to usage. While determining patterns of file block usage, other services may be easily added. One aspect of the invention is a system that has a processor coupled to a non-transitory store of computer-executable instructions which cause the processor to receive and fulfill file block requests submitted by an application server. While doing so, the processor is enabled to record file block activity, meaning file block requests and file block writes and report congestion if the activity is not prompt. In that event, the processor may analyze file input/output (i/o) patterns for storage optimization. In other words, copies of popular file blocks may be stored near the application servers which operate on them frequently.

In an embodiment, the system stores past patterns in file block requests and then can compare new file block requests to past patterns. In the event that new file block requests are not substantially similar it can trigger which interrupts fulfillment of file block requests out-of-norm for an application. This capability is independent and can be complementary to traditional and conventional file system permissions which depend on user and group authentication and access control.

In an embodiment, the system also includes computer executable instructions and circuits to cause the processor to authenticate applications as a condition to accepting any file block requests. This means that independent of the user permissions, when a file block access is requested by an application for which it is inappropriate, it can be denied. This can prevent data from being corrupted or breached.

In an embodiment, the system can also include computer executable instructions and circuits to cause the processor to encrypt file block writes and decrypt file block reads for authenticated applications. This allows data at rest to be encrypted and only decrypted upon demand for use with a particular application.

Another aspect of the invention is an apparatus which includes a viewport circuit; the viewport circuit interposed between an application server and a distributed file system. A transaction activity store is coupled to the viewport circuit so a record is made of each file block request. A pattern agent circuit is coupled to the transaction activity store. This apparatus has the ability to analyze stored file block activity and compare new activity with stored patterns as well as detect when network congestion is causing a performance bottleneck.

In an embodiment the apparatus also has a rules engine, coupled to the viewport circuit; and a rule base store, coupled to the rules engine. The rules cause the apparatus to take actions or deny access when rules are triggered by file block activity. One rule can locate duplicate file blocks in the distributed file system to optimize performance. Another rule can trigger warnings, reports, or interrupt file block requests that are anomalous i.e. not normal for the application or for the file blocks.

In an embodiment, the apparatus also includes a decryption/encryption engine. Upon authentication of an application, file blocks are encrypted or decrypted as part of the file block request. Other applications do not receive the benefit of this circuit.

Another aspect of the invention is a method of operation for the apparatus including following processes: receiving file block requests; storing file block requests; and analyzing patterns in file block requests.

In an embodiment, the method also reading a rules base on file block patterns; and blocking out-of-norm file block requests.

In an embodiment, the method also includes authenticating applications; and discarding file block requests from applications which fail authentication.

In an embodiment, the method also includes checking rules on applications for a type of file; and discarding file block requests from applications which are not approved for the type of file.

In an embodiment, the method includes decrypting/encrypting file blocks for vetted applications which are authenticated for the type of file.

File blocks of version-controlled files are individually provisioned, tracked, load-balanced, and secured by an interposer apparatus.

File blocks may be distributed across a network depending on who is creating or using them. When a user has selected a version of a file and an application needs a file block, the apparatus performs authentications and retrieves it from the most convenient location.

A combination of application, resource location, schedule and user authentication is verified by the apparatus prior to reading, writing, or operating on each file block.

Rules control the provisioning of file blocks to applications: e.g. certain applications, while compatible with the format of a file block, may be disallowed as a policy; the signature of the application may indicate it has been modified from a trusted version, such as by insertion of a virus or other malware; resource locations include storage hardware with or without removable media; some file blocks may not be allowed to be written to flash drives; time of day or day of week may be inappropriate or highly unusual for accessing certain file blocks; and file blocks may be decrypted under certain conditions.

Recording past traffic patterns in the network enables the apparatus to tune performance by staging file blocks in the vicinity of most commonly utilized storage or processor resources as well as to recognize atypical data flows.

The apparatus keeps a record of which file blocks were requested where and when. Changing traffic patterns con be measured and the location of stored file blocks adjusted to reduce latency. An exceptionally atypical request for file blocks may trigger a notification or even an interruption.

Desuetude of file blocks in one vicinity is measured by the apparatus which then improves storage and network efficiency by anticipating future traffic patterns.

Periodically all local file blocks may be removed and the storage refilled on demand. Or, the file blocks which have not been accessed within a period may be deleted and the storage defragmented. Or scheduled future jobs may have a list of file blocks that should be preloaded for better throughput.

Block by block encryption and decryption of only selected blocks provides more granular security of some versions and higher performance for other versions compared with file level encryption/decryption.

It may be undesirable to read an entire file to decrypt a single record. If each block is encrypted by itself, it may be decrypted quickly. And some file blocks may be more sensitive than other file blocks. A mixture of encrypted and plaintext file blocks can reflect the difference in privacy between versions of a file.

One aspect of the invention is an interposer apparatus that includes a network interface to receive file block requests from an application; a circuit that tracks a pattern of file block traffic including the requesting application, and the location of a related resource in the network; a file state view circuit configured to create, store, and retrieve metadata about file blocks, the versions of files that each block is a component of, and the location of each block in a local file block store whereby file blocks that are identical in multiple versions of a file are not redundantly stored; wherein the local file block store for all file blocks that comprise versions of files whose metadata is stored in the file state view circuit, coupled to both the processor and to the file state view circuit.

In an embodiment, the apparatus also includes a circuit to analyze file block traffic patterns for load balancing; and a circuit to store file blocks into resources local to anticipated requests.

In an embodiment, the apparatus also includes a circuit for triggering an alert or suspension process upon detecting atypical file block request pattern of applications and resource locations.

In an embodiment, the apparatus also includes a circuit for authentication of both a user and an application for fulfillment of each file block request.

In an embodiment, the apparatus also includes a decryption circuit enabled to decrypt a file block for both an authenticated user and authenticated application.

In an embodiment, the apparatus also includes a circuit to authenticate both a resource location and an application for fulfillment of a file block request.

In an embodiment, the apparatus also includes a decryption circuit enabled to decrypt a file block for both an authenticated location and authenticated application.

In an embodiment, the apparatus also includes a circuit to enable a file block request based on time of day and day of week.

In an embodiment, the apparatus also includes a circuit to decrypt a file block when authenticated for time of day and day of week.

In an embodiment, each application is further authenticated as digitally signed.

Another aspect of the invention is a method for operating an interposer apparatus having the processes: receiving file block requests from an application for a version of a file in a distributed versioned file system; storing said file block requests; and analyzing patterns in applications and in resource locations of said file block requests to identify causes of long latency and congestion.

In an embodiment, the method also includes reading a rules base on normal file block request patterns; and blocking out-of-norm file block requests.

In an embodiment, the method also includes authenticating applications; and discarding file block requests from applications which fail authentication.

In an embodiment, the method also includes checking rules on applications for each type of file; and discarding file block requests from an application that is not approved by a rule for the type of file.

In an embodiment, the method also includes decrypting/encrypting a file block for o vetted application which is authenticated for the type of file.

Another aspect of the invention is a system including a processor coupled to non-transitory store of instructions to cause the processor: to receive and fulfill file block requests submitted by an application server; to record file block activity and report congestion; and to analyze patterns for storage optimization.

In an embodiment, the system also includes stored computer executable instructions and circuits to cause the processor: to recognize patterns in file block requests; and to interrupt fulfillment of file block requests out-of-norm for an application.

In an embodiment, the system also includes stored computer executable instructions and circuits to cause the processor: to authenticate applications as a condition to accepting any file block requests.

In an embodiment, the system also includes stored computer executable instructions and circuits to cause the processor: to encrypt file block writes and decrypt file block reads for authenticated applications.

Another aspect of the invention is an apparatus that includes: a viewport circuit; the viewport circuit interposed between an application server and a distributed file system, whereby a file block request by an application is transformed into a request for a file block of a version of a file; a transaction activity store coupled to the viewport circuit, whereby each file block request is recorded; a pattern agent circuit coupled to the transaction activity store, whereby a series of file block requests are assigned to a pattern; a rules engine, coupled to the viewport circuit, whereby patterns of file block requests are compared with rules; and a rule base store, coupled to the rules engine, whereby file block requests that are out-of-norm are suspended; and a decryption/encryption engine, whereby file blocks are limited to authenticated applications.

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

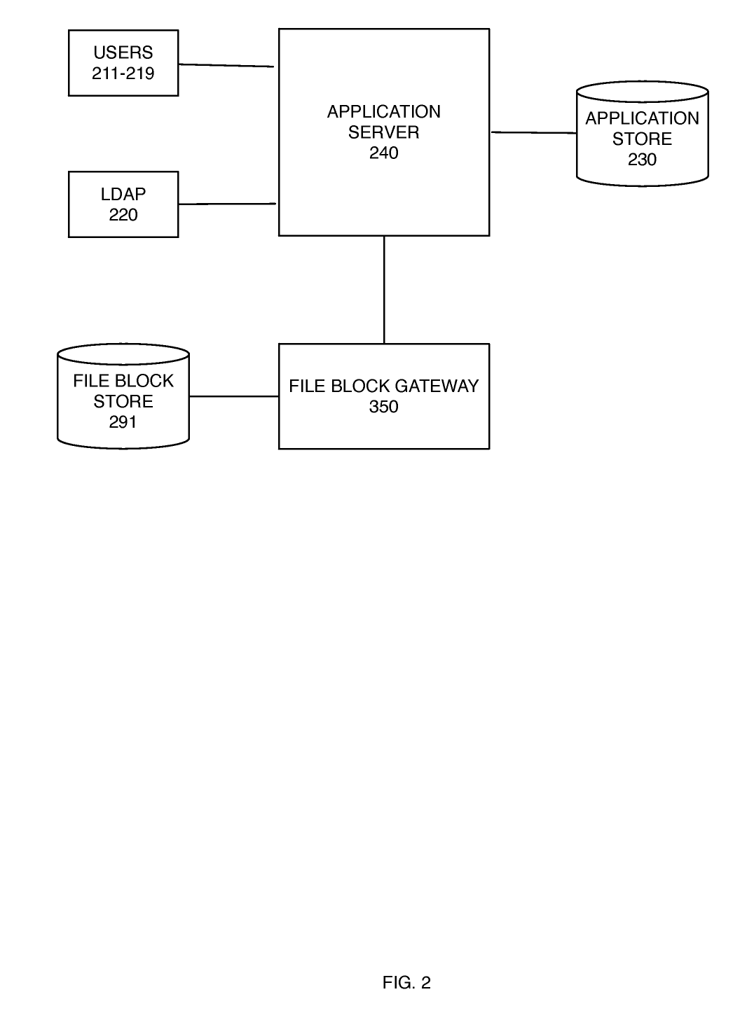

Referring now to the figures: FIG. 2 is a system that improves performance of a distributed file block system and provides additional security and privacy over conventional file systems. A user 211-219 upon presenting credentials suitable for authentication by LDAP 220 is provided access to resources such as an application server 240 and executable programs 230 to access files 291. Because files are made up of file blocks some of which may be invariant among versions of a file or even common across multiple files, a file block gateway may provision the most convenient file block to an application that meets its needs. This avoids congestion and contention over network and file storage resources.

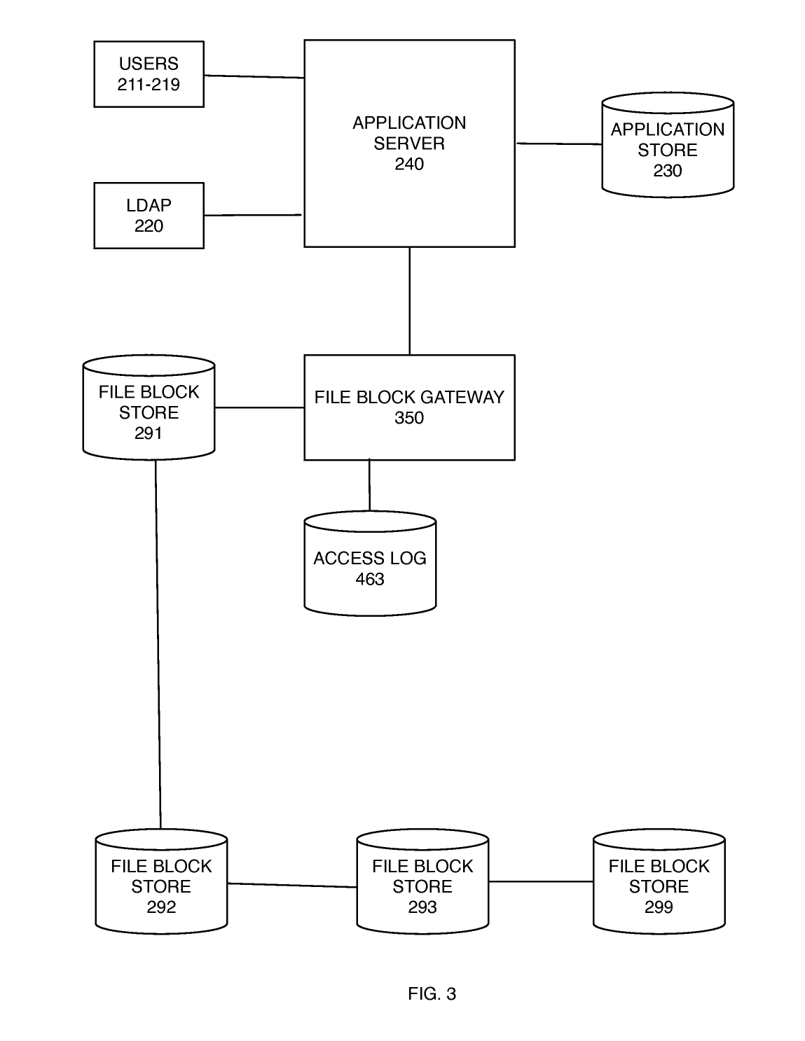

FIG. 3-7 are illustrative embodiments of an apparatus embodiment of the subject matter.

FIG. 3 shows a file block gateway apparatus 350 interposed between an application server apparatus 240 and a plurality of file block stores 291-299. While a conventional user authentication access control system 220 enables a user 211-219 to resources (application server 240, application store 230, and files) the file block gateway 350 locates and provisions an appropriate version controlled file block to an application from a distributed file block system. The file block gateway minimizes file block duplication except for optimized performance and reduced network congestion. Each file block access is recorded into a log 463. The gateway improves throughput of an application server by anticipating future file block access requests by locating blocks to stores near to their needed location. The improvement disclosed herein enables re-optimization of the distribution of file blocks according to usage.

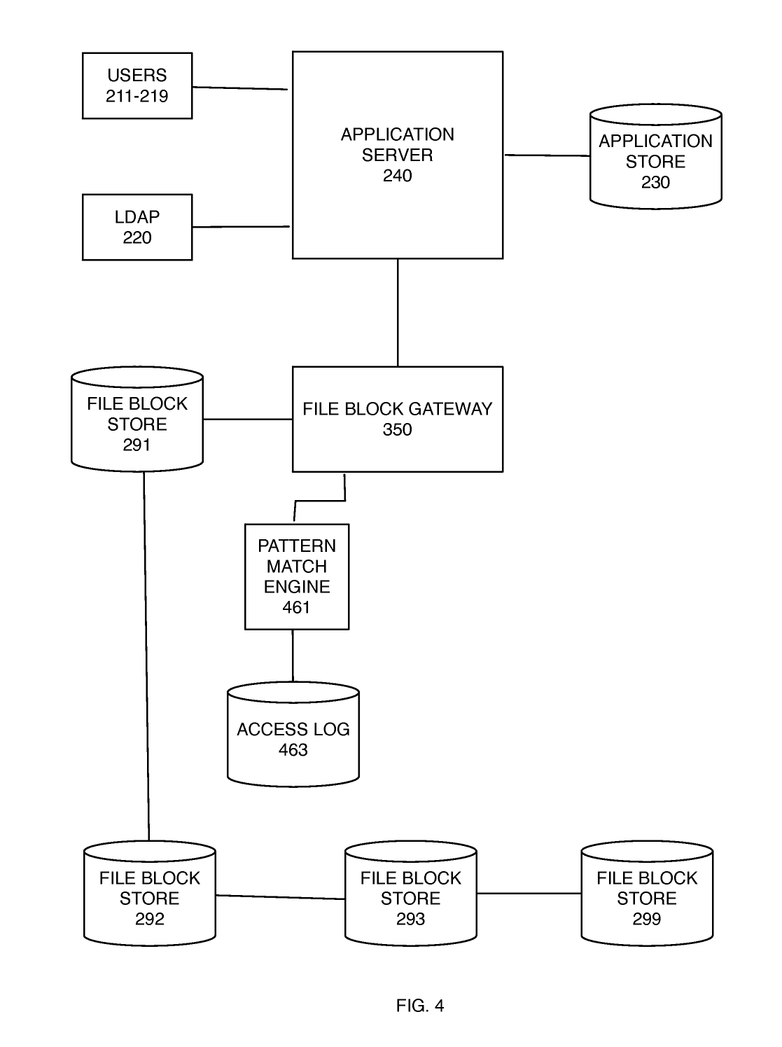

FIG. 4 shows an embodiment of the file block gateway apparatus 350 coupled to a pattern match engine 461, which is coupled to an access log store 463. Each file block access is recorded and stored into the access log, which can be analyzed by the pattern match engine. As work load shifts between application servers, the optimum location of file blocks may also be improved to reduce network congestion or file access contention. Pattern matches which are out-of-norm may also trigger security warnings or interventions.

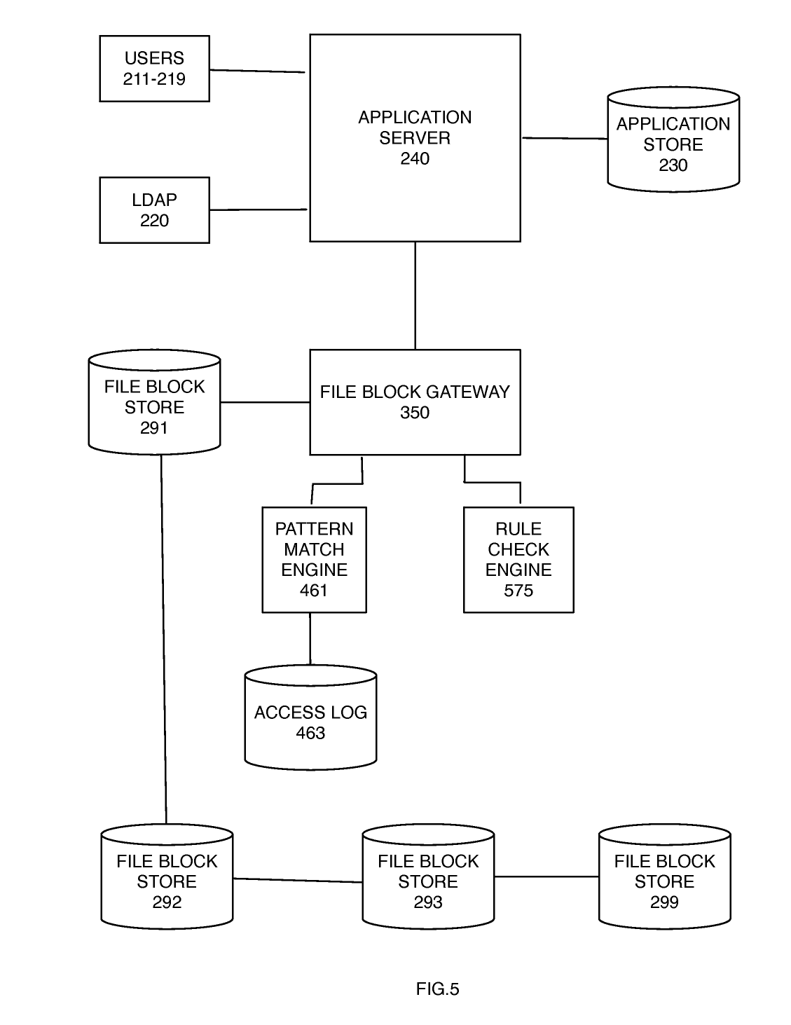

FIG. 5 shows an embodiment of the file block gateway apparatus 350 coupled to a rule check engine 575. Warnings, interventions, or access denials may be triggered by applying pattern matching rules.

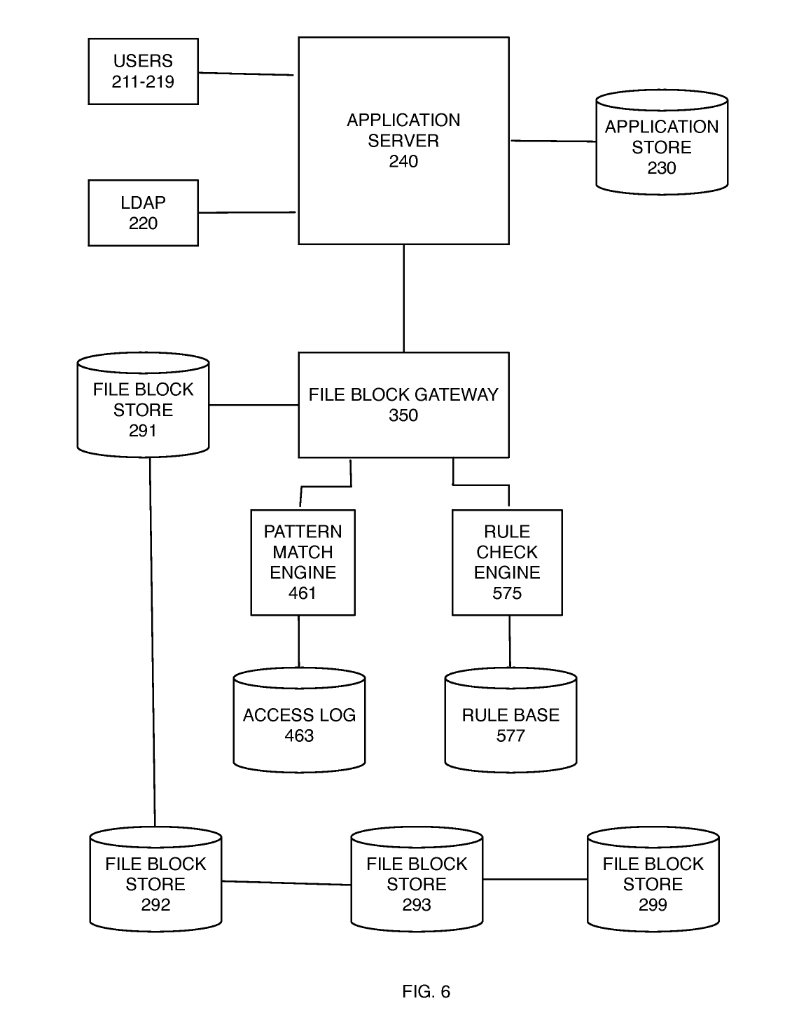

FIG. 6 shows an embodiment of the file block gateway apparatus 350 coupled to a rule check engine 575 which is coupled to a rule base 577. Complex rules can be encoded into the rule base to enable or deny access according to time of day, or type of file, or to enforce specific application versions or identities. This is orthogonal and additional to conventional user access controls. A conventional superuser may still be denied access to a certain file type from an application that is inappropriate using the rule check engine attached to the file block gateway.

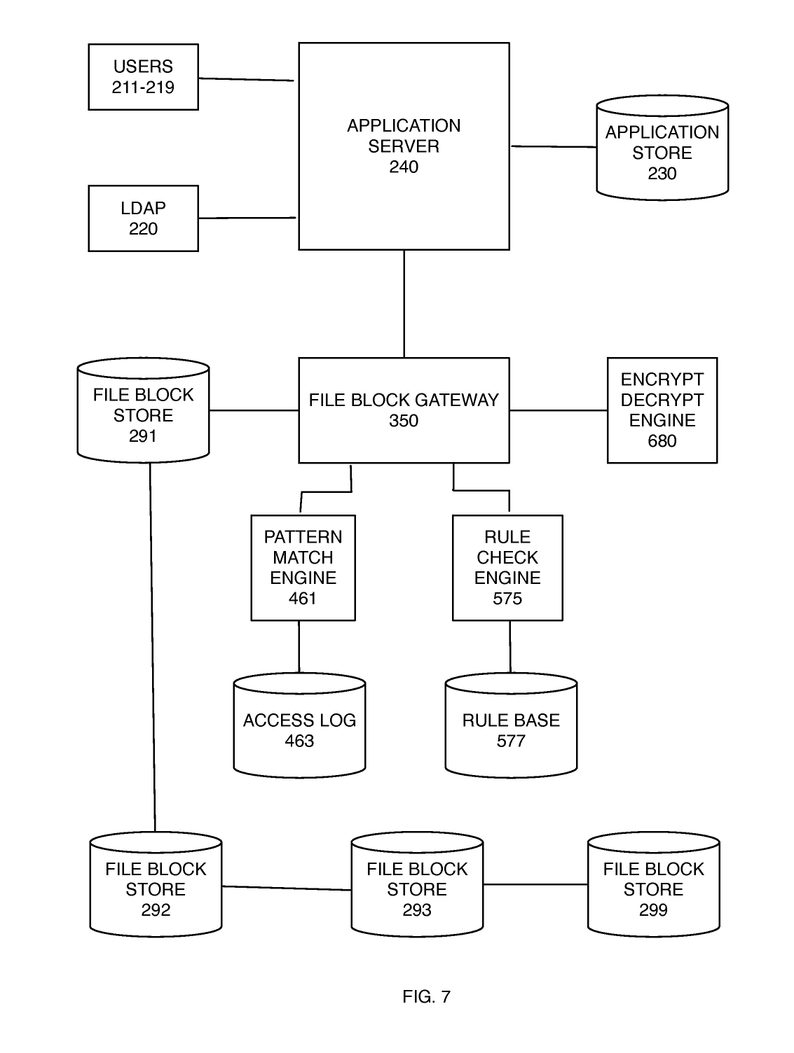

FIG. 7 shows an embodiment of the file block gateway apparatus 350 coupled to an encrypt/decrypt engine 680. This provides file blocks encrypted at rest and only accessible to applications which are validated perhaps by signature. In this embodiment, even if physical access to the file block stores 291-299 are breached, the file block remains protected by its encryption.

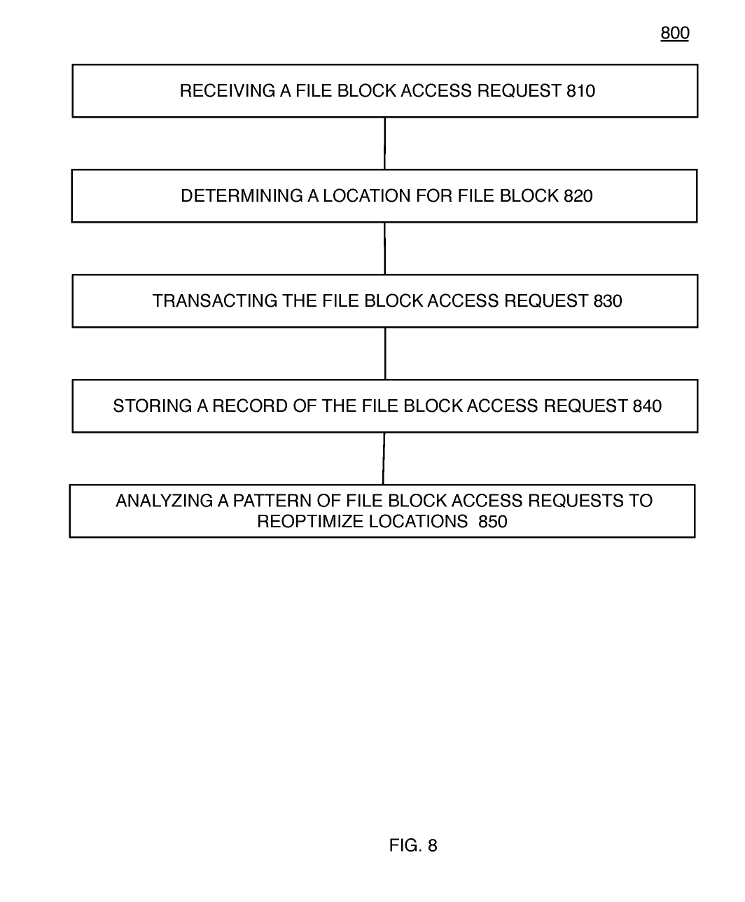

FIG. 8 is a flowchart of method steps for a process embodiment of the subject matter. As shown in FIG. 8, a method of operation for a file block gateway apparatus comprising a processor coupled to non-transitory instructions to cause the processor to perform: receiving from an application executing on an application server a file block access request 810; determining from a metadata store a location for the file block 820; transacting the file block access request 830; storing a record of the file block access request into a file block access request store 840; and analyzing a pattern of file block access requests to re-optimize locations for file blocks to reduce congestion and contention for network and file block store resources 850.

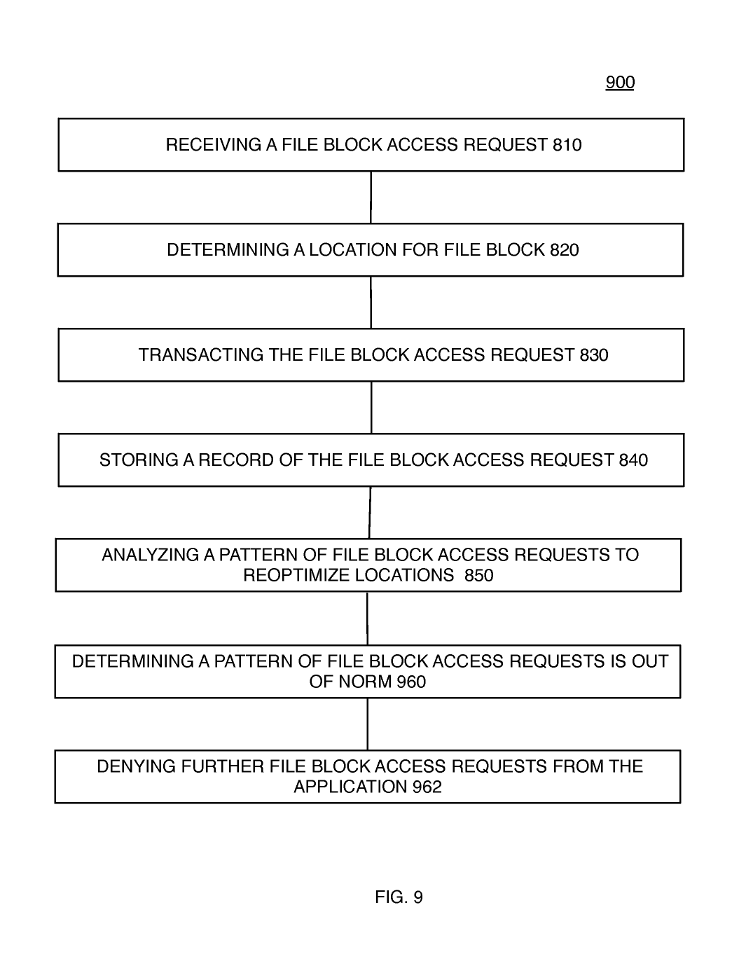

FIG. 9 shows additional steps to the method: determining a pattern of file block access requests is out-of-norm 960; and denying further file block access requests from the application 962.

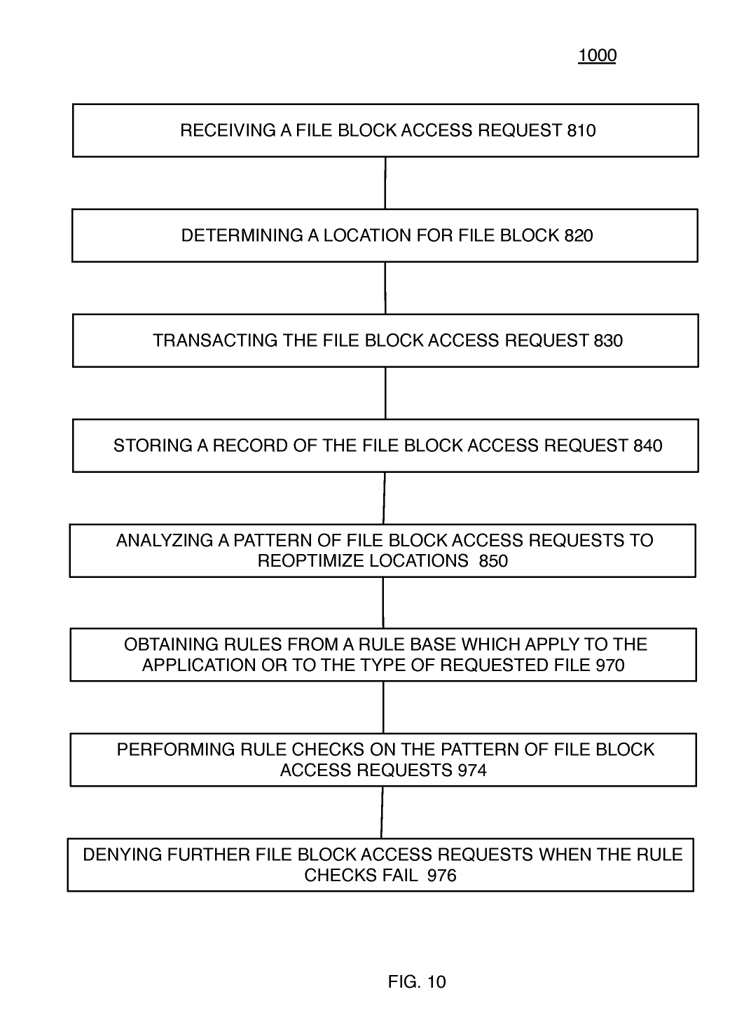

FIG. 10 shows additional steps to the method: obtaining rules from a rule base which apply to the application or to the type of requested file 970; performing rule checks on the pattern of file block access requests 974; and denying further file block access requests when the rule checks fail 976.

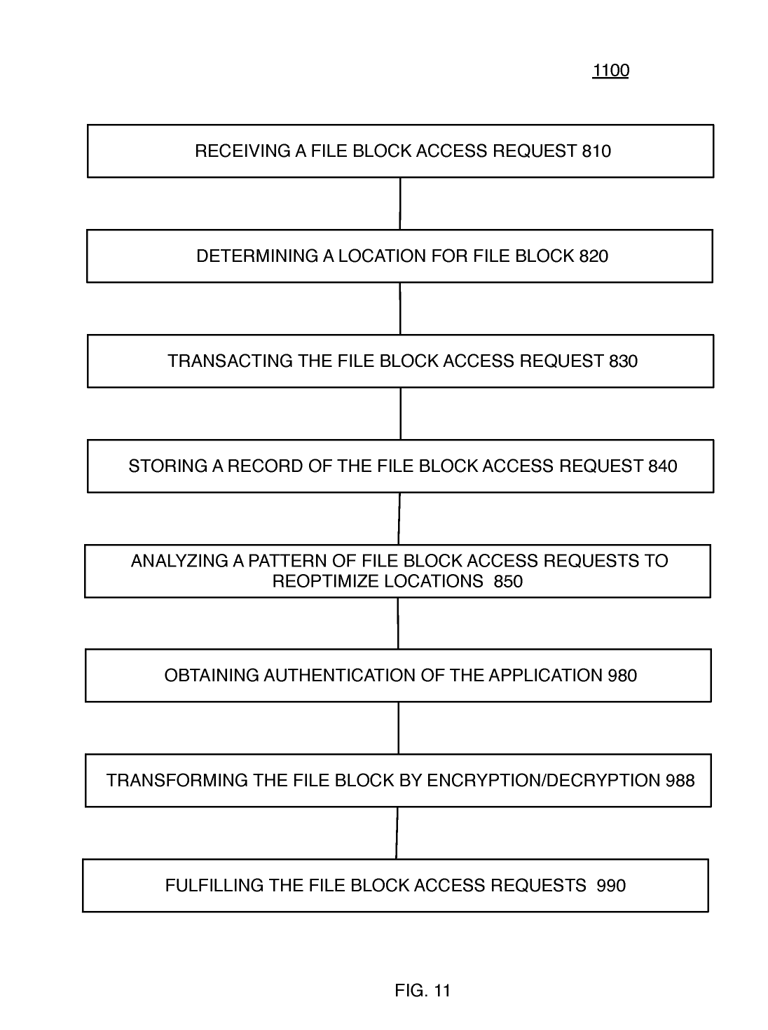

FIG. 11 shows additional steps to the method: obtaining authentication of the application 980; transforming the file block by encryption/decryption 988; and fulfilling the file block access request 990.

### CONCLUSION

The present invention is easily distinguished from conventional file system access control lists by its finer grain and orthogonal discrimination. Rather than being solely user or identity oriented, the system additionally permits certain trusted applications to operate on file blocks in appropriate behavior patterns. The file blocks may be encrypted at rest and only decrypted for signed or verified applications having a recognized checksum. An application which has been tampered with will receive a obfuscated block of bits. A trusted application can be associated with a behavior pattern but an out-of-character or out-of-time-period file block access can trigger a denial.

The subject matter of this application can protect data even when a user's credentials have been stolen or misused by denying access to other than specific applications or specific versions of specific applications by considering digital signatures or checksums.

The techniques described herein can be implemented in digital electronic circuitry, or in computer hardware, firmware, software, or in combinations of them. The techniques can be implemented as a computer program product, i.e., a computer program tangibly embodied in a non-transitory information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

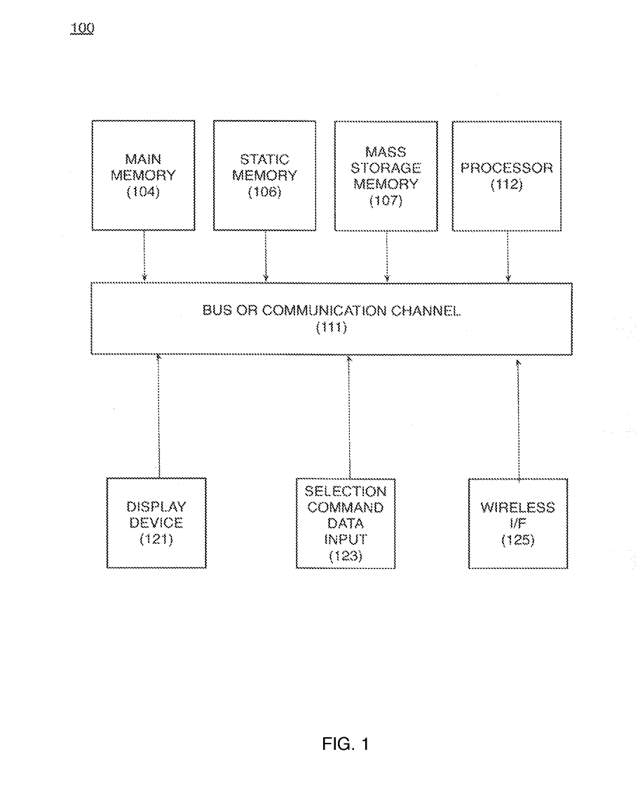

FIG. 1 illustrates an exemplary programmable processor comprising a bus or communication channel 111 coupling main memory 104, static memory 106, mass storage memory 107, and a processor circuit 112 for executing instructions, and in embodiments at least one interface to couple a display device 121, a selection command data input 123, and/or a wireless interface 125.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; internal hard disks or removable disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

1. An interposer apparatus comprises:
a network interface to receive file block requests from an application;
a circuit that tracks a pattern of file block traffic including the requesting application, and the location of a related resource in the network;
a file state view circuit configured to create, store, and retrieve metadata about file blocks, the versions of files that each block is a component of, and the location of each block in a local file block store whereby file blocks that are identical in multiple versions of a file are not redundantly stored; wherein the local file block store for all file blocks that comprise versions of files whose metadata is stored in the file state view circuit, coupled to both the processor and to the file state view circuit.

2. The interposer apparatus of claim 1 further comprises:
a circuit to analyze file block traffic patterns for load balancing; and
a circuit to store file blocks into resources local to anticipated requests.

3. The interposer apparatus of claim 1 further comprises:
a circuit for triggering an alert or suspension process upon detecting atypical file block request pattern of applications and resource locations.

4. The interposer apparatus of claim 1 further comprises:
a circuit for authentication of both a user and an application for fulfillment of each file block request.

5. The interposer apparatus of claim 4 further comprises:
a decryption circuit enabled to decrypt a file block for both an authenticated user and authenticated application.

6. The interposer apparatus of claim 1 further comprises:
a circuit to authenticate both a resource location and an application for fulfillment of a file block request.

7. The interposer apparatus of claim 6 further comprises:
a decryption circuit enabled to decrypt a file block for both an authenticated location and authenticated application.

8. The interposer apparatus of claim 1 further comprises:
a circuit to enable a file block request based on time of day and day of week.

9. The interposer apparatus of claim 9 further comprises:
a circuit to decrypt a file block when authenticated for time of day and day of week.

10. The interposer apparatus of claim 1 wherein application is further authenticated as digitally signed.

11. A method for operating an interposer apparatus comprising:
receiving file block requests from an application for a version of a file in a distributed versioned file system;
storing said file block requests; and
analyzing patterns in applications and in resource locations of said file block requests to identify causes of long latency and congestion.

12. The method of claim 11 further comprising:
reading a rules base on normal file block request patterns; and
blocking out-of-norm file block requests.

13. The method of claim 12 further comprising:
authenticating applications; and
discarding file block requests from applications which fail authentication.

14. The method of claim 13 further comprising:
checking rules on applications for each type of file; and
discarding file block requests from an application which is not approved by a rule for the type of file.

15. The method of claim 14 further comprising:
decrypting/encrypting a file block for o vetted application which is authenticated for the type of file.

16. A system comprising a processor coupled to non-transitory store of instructions to cause the processor:
to receive and fulfill file block requests submitted by an application server;
to record file block activity and report congestion;
and to analyze patterns for storage optimization.

17. The system of claim 16 further comprising stored computer executable instructions and circuits to cause the processor:
to recognize patterns in file block requests; and
to interrupt fulfillment of file block requests out-of-norm for an application.

18. The system of claim 17 further comprising stored computer executable instructions and circuits to cause the processor:
to authenticate applications as a condition to accepting any file block requests.

19. The system of claim 18 further comprising stored computer executable instructions and circuits to cause the processor:
to encrypt file block writes and decrypt file block reads for authenticated applications.

20. An apparatus comprising:
a viewport circuit; the viewport circuit interposed between an application server and a distributed file system, whereby a file block request by an application is transformed into a request for a file block of a version of a file;
a transaction activity store coupled to the viewport circuit, whereby each file block request is recorded;
a pattern agent circuit coupled to the transaction activity store, whereby a series of file block requests are assigned to a pattern;
a rules engine, coupled to the viewport circuit, whereby patterns of file block requests are compared with rules; and
a rule base store, coupled to the rules engine, whereby file block requests that are out-of-norm are suspended;
and a decryption/encryption engine, whereby file blocks are limited to authenticated applications.
